(19) United States
(12) Patent Application Publication
(10) Pub. No.: US 2026/0266419 A1
(43) Pub. Date: Sep. 10, 2026

(54) MAGNETICALLY MOUNTED USER INTERFACE DEVICE, AND KIT THEREFOR

(71) Applicant: Systec & Solutions GmbH, Karlsruhe (DE)

(72) Inventor: Philipp LINDER, Karlsruhe (DE)

(73) Assignee: Systec & Solutions GmbH, Karlsruhe (DE)

(21) Appl. No.: 18/718,505

(22) PCT Filed: Dec. 2, 2022
(86) PCT No.: PCT/EP2022/084273

§ 371 Date: Jun. 11, 2024

(30) Foreign Application Priority Data
Dec. 22, 2021 (DE) 10 2021 134 403.4

(51) Int. Cl. F16M 13/02; F16B 1/02

(52) U.S. Cl. CPC F16M 13/02; F16B 1/02; F16B 2200/83

(57) ABSTRACT

A user interface device has a housing and a holding device. The holding device has an opening, in which the housing of the user interface device is accommodated in a flush and detachable manner. At least one first magnetic connector element is present in the or on the housing. At least one second magnetic connector element is present in the or on the holding device. A position of the at least one first magnetic connector element corresponds to a position of the at least one second magnetic connector element, so that the housing arranged in the opening is mounted in a flush and detachable manner in the opening by means of a predefinable attractive force, which the at least one first magnetic connector element exerts on the at least one second magnetic connector element.

### CROSS-REFERENCE TO RELATED APPLICATION

This application is a national stage application, filed under 35 U.S.C. § 371, of International Patent Application PCT/EP 2022/084273, filed on Dec. 2, 2022, which claims the benefit of German Patent Application DE 10 2021 134 403.4, filed on Dec. 22, 2021.

### TECHNICAL FIELD

The application relates to a magnetically mounted interface device, which has a housing and a holding device for the housing, as well as a set for handling the magnetically mounted user interface device.

### BACKGROUND

Different fastening options for human-machine interface devices to mounts or walls, for example, are known from the prior art. “Human-machine interface devices”, also referred to as user interface devices, are understood to be, e.g., output devices, such as monitors and touch-sensitive displays or also input devices, such as keyboards. The fastening to higher-level mounts serves the purpose of protecting the devices and also of the skillful use. In the case of the wall fastening of monitors, they are often fastened to wall holders with arm. Countersunk devices are further known, in the case of which special frames are embedded in the wall, so that a monitor can be installed in a flush-mounted manner with the wall surface. In the case of the known holders, the fastening of the user interface device is typically established via screw connections. When a replacement of, for example, non-functional hardware is to take place, the screw connections have to be detached in a complex manner.

For example, US 2018/307274 A1 discloses mounting options for an electronic device, in this case a portable information device, which is detachably connected to a unit, both of which can be accommodated in a docking station. The docking station has a docking section with a holding section on which the portable information device rests so that it is flush with the housing of the docking station. The docking station also has a forced movement section with magnets that are mounted in the housing of the docking station corresponding to the fastening magnets of the extension unit and are designed in such a way that the extension unit is separated from the information device resting on the holding section in order to use the gap thus created as a ventilation duct to dissipate the heat generated during the charging process, for example.

EP 2 364 005 B1 relates to a mobile terminal device which consists of a main body and a connected extension module, wherein the main body comprises coupling elements and the extension module having correspondingly placed magnets.

Finally, U.S. Pat. No. 6,510,048 B2 discloses a so-called computer device with an improved keyboard assembly for use in the computer device, which may have a movable keyboard that can be opened or removed for easy access to the internal components of the computer device. This keyboard can also be held in place with a magnetic keyboard attachment system.

### SUMMARY

An object of the present application is to provide mounted user interface devices with skillful detachability of the user interface device from the holding device.

A further object consists in providing a device, which makes it possible to detach a user interface device, which is magnetically mounted, from its mount with little assembly effort.

According to a first embodiment of the magnetically mounted user interface device, it comprises a housing and a holding device, which has an opening, in which the housing of the user interface device is accommodated in a flush and detachable manner in the mounted or held state, respectively.

At least one first magnetic connector element is arranged in the or on the housing. When several magnetic connector elements are present, magnetic connector elements can be present in as well as on the housing. At least one second magnetic connector element is arranged on the holding device, with regard to the presence of several second magnetic connector elements, the same applies here as for first magnetic connector elements. A position of the at least one first magnetic connector element thereby corresponds to a position of the at least one second magnetic connector element, so that the housing arranged in the opening is mounted in a flush and detachable manner in the opening by means of a predefinable attractive force, which the one first magnetic connector element exerts on the corresponding second magnetic connector element. With regard to the cooperation with a second magnetic connector element, a first magnetic connector element quasi forms a pair; if several first magnetic connector elements are present, a sufficient number of second magnetic connector elements, which correspond with regard to magnetism, should be present.

The position of the first magnetic connector element in the or on the housing is thereby matched with the position of the second magnetic connector element in the or on the holding device and the respective two magnetic connector elements correspond in such a way with regard to their design and geometry that when arranging the housing in the opening of the holding device, a predefinable attractive force between the respective magnetic connectors of the respective pair cooperates so that a fastening assembly is formed. Furthermore, the user interface device has a locking device, which locks the housing in the holding device. The locking device thereby has one or several engagement means, which is or are movably mounted, respectively, in the housing between an installed position and a locked position. Corresponding thereto, one or several engagement opening(s) are formed on the holding device for engagement with the engagement means in the locked position. The user interface device can thus be protected against unwanted removal. In addition, the mounting of the user interface device in the holding frame is improved.

Further, the user interface device comprises an installation enclosure for the dust-free storing of the display housing on a side of the holding device facing away from the housing. The fastening assembly thus becomes permissible for the standard IP65 required in clean rooms.

“Fastening assembly” means here that the housing is held in or on the holding device, respectively.

Here, “user interface devices” refers to any devices, which provide a human-machine interface, by means of which an output or an input with regard to a data processing unit, which is or can be electronically coupled thereto, is possible. Devices of this type can be output devices, such as, for example, monitors, further input devices, such as keyboards, or combined input/output devices, respectively, such as touch-sensitive displays. Beyond the frequently present general understanding, “user interface devices” in the present case refers to the device, as explained above, thus a monitor, a keyboard or a touch-sensitive display, but beyond that in fact also the housing for these devices and additionally the mount (“holding device”), which holds the device arranged in the housing in place and thus holds the secure and nonetheless detachable fastening to a wall cut-out, thus a “recess” or a space, which will be further described below.

A holding device can be a frame element (holding frame), which is arranged like a window frame in an opening provided for this purpose in a wall or directly on the wall or also on a panel, an arm, which is fastened to the wall, or which is arranged on a comparable component, wherein the frame element is designed so that it securely frames the housing of the user interface device. A holding frame can further also be realized directly in a wall or a wall element, such as a panel, as recess or soffit, in order to form the opening for accommodating the housing. Here, “recess” means that a polygonal, preferably rectangular or square surface is cut out of the surface of the wall or the panel, wherein a rear wall can remain, but does not have to. The side surfaces of the polygon are important, which carry the at least one, but suitably several, magnetic connector element(s). It goes without saying that the number of the magnetic connector elements depends on the size and the weight of the user interface device-the person of skill in the art can easily determine them, however, and can consider them during the manufacture of the device.

Every material that is sufficiently stable for such a frame, such as metal or a hard plastic, can be used thereby. Sheet metals, which are punched into shape and the production of which is affordable, can be used thereby.

The magnetic mount of the user interface device in the holding device provides for a simple and simultaneously firm arrangement of the user interface device therein or in the holding frame or the recess, but simultaneously also an easy detaching of the device therefrom, when the attractive force of the magnetic connector elements, which can be predefined by distance and magnetic strength, is overcome. Monitors and touch-sensitive displays can be assembled quickly by means of this magnetic mount by means of a simple insertion into the respective holding frame or the recess. For the disassembly, the monitor can be detached from its mount again by simply pulling out, for example for replacement purposes.

In a further embodiment of the user interface device, the holding frame or the recess, respectively, has one or several side panel(s) for laterally guiding the housing of the user interface device. The side panel is thereby preferably arranged on a side edge of the holding frame or of the recess, respectively-in the case of a square or rectangular holding frame or alternatively of the recess, there can also be two side panels arranged located opposite one another. During the assembly of the user interface device, the housing is laterally guided and held securely by means of the side panels. The side panels ensure that the magnetic connector elements can meet correspondingly.

According to a further embodiment of the user interface device, it can further be provided that the holding frame or the recess, respectively, has an upper holding rail, which is arranged on an upper longitudinal edge of the opening, and a lower holding rail, which is arranged on a lower longitudinal edge of the opening. It is also possible that only one holding rail is present, depending on the dimensions of the user interface device to be held or on how heavy it is. The holding rails can be provided as angle plates as separate component, which are to be attached. Alternatively, the holding rails can also be made in one piece with the holding frame. It is thus possible to bend sheet metal strips out of the opening of the holding frame in order to manufacture the angled holding rails.

Devices, such as monitors, are generally very expensive devices, so that it is preferred to accordingly arrange holding rails in pairs in each case; the same applies for side panels. A secure mounting of the user interface device is thus made possible in an advantageous manner.

Together with the side panels, the holding rails also improve the centered insertion of the housing of the user interface device into the holding device.

According to a further embodiment of the user interface device, several first magnetic connector elements are present so as to be distributed in the or on the housing, and several second magnetic connector elements so as to be distributed in the or on the holding device. For each first magnetic connector element, a second magnetic connector element is thereby arranged in a corresponding manner and so as to form a pair therewith.

When holding rails are provided, the second magnetic connector elements are present on the upper or lower holding rail, respectively.

A few (e.g., 2, 4, 5 . . . ) or many (10, 15, 20 . . . ) magnetic connector elements can be provided, which are preferably arranged equidistantly along a line, which is parallel to an upper edge of the housing; the paired partners are present accordingly.

The magnetic connector elements can have different shapes, such as disk-shaped, square or rectangular, they are fastened, for example placed, adhered or screwed into recesses provided for this purpose. The magnetic connector elements are particularly preferably formed as discs, which have a bore in their center and which are screw-connected. The first magnetic connector elements can be installed completely into the housing, so that they are not visible from the outside. This also applies for the second magnetic connector elements, however accordingly in the connection with the holding rail or the holding rails.

According to yet a further embodiment of the user interface device, the or the first and second magnetic connector elements are selected from magnetic or magnetizable materials, respectively. The magnetic material can be formed by means of a permanent magnet or also electromagnet. It can further be provided that only one magnetic connector element is a magnet, thus an active component, and the second magnetic connector element consists of a magnetizable material. The selection as to whether both magnetic connector elements or only one partner of a magnetic connector element pair is a magnet can be selected depending on the design of the housing or of the holding rails.

According to yet a further embodiment of the user interface device, the housing has, on its rear side facing the holding device, mechanical guide pins for the guided installation of the user interface device. The guide pins can be engaged with corresponding guide openings in the holding device, before the magnetic attraction acts between the magnetic connector elements.

During the assembly of the user interface device in the holding frame, the guide pins first come into contact with the guide openings in the holding rails, until the attractive force of the magnetic connector elements is so strong that the magnetic mounting inserts itself, whereby the user interface device can be inserted in a centered manner. The assembly is simplified thereby.

According to yet a further embodiment of the user interface device, the locking device can preferably engage with the holding frame, wherein, in addition to engagement openings, a tongue and groove behind an edge of the holding frame is also conceivable. One or several locking device(s) can be provided for each user interface device, depending on the size of the user interface device to be installed.

In a preferred embodiment of the user interface device, the engagement means can be a linearly displaceable pin. Alternatively, the engagement means is a pivotably mounted hook. The hook can thereby be pivoted in a plane parallel to the holding device or also in a plane at a right angle to the main plane of the holding frame or of the recess, thus in the longitudinal extension thereof. Other designs are further possible, which have a moved element in or on the housing and can simultaneously be engaged with the holding device. In an alternative embodiment of the user interface device, a latching connection can also be provided, wherein one or several spring ball pin(s), spring plungers or spring-loaded pressure pieces are embedded in the holding frame or in the housing, respectively, of the user interface device. A groove for fixing purposes is present on or in the respective counter surface of the housing of the user interface device or of the holding frame, respectively. This type of engagement means can further be realized in the guide pins. It does not require an actuating element and can be assembled and disassembled again in a tool-free manner by using a slightly increased force.

In a further embodiment of the user interface device, the holding rails can be formed in the installation enclosure. For this purpose, the holding rails in the form of angle plates are welded or adhered to an inner surface of the installation enclosure; a one-piece formation of the holding rails with the installation enclosure is likewise possible.

In yet a further embodiment of the user interface device, the installation enclosure is formed in one piece as deep-drawn component. Alternatively, the installation enclosure can be in several pieces and can be constructed, for example, of a collar and a cover, which can be assembled thereto in a fluid-tight manner, wherein the cover can be removed from within the enclosure or outside of the enclosure. The cover can comprise the complete width of the enclosure or only a portion thereof. The advantage of this is an improved access to electronic lines within or outside of the enclosure, depending on which structural specifications are present. In an alternative embodiment of the user interface device, the installation enclosure can further also be formed in one piece with the holding frame.

The user interface device within the fastening assembly can further also be electrically connected to a data line and a power supply via electrical terminals provided for this purpose. For this purpose, the holding device or also the installation enclosure has a cable connection. A firmly installed connection in the manner of a docking station can preferably be present, so that, when the user interface device is inserted into the holding frame or the recess, said user interface device is simultaneously also connected to the electrical terminals when connecting the connection of the magnetic connector elements to one another.

An assembly set for such a user interface device, which is magnetically mounted, comprises an actuating tool, which has a magnet and which is formed to move the engagement means by means of magnetic force between the installed position and the locked position. “Engagement means” thereby refers to one or several engagement means, which is or are movably mounted, respectively, in the housing between an installed position and a locked position and locks/lock the housing in the holding device as part of the locking device.

Due to the fact that the engagement means has a magnetic or magnetizable material and the actuating tool has a magnet, the engagement means can be moved by the actuating tool by means of magnetic force between the installed position and the locked position. The magnet of the actuating tool can be a permanent magnet or an electromagnet. The actuating tool thus provides a simple option for moving the movable engagement means of the locking device from the outside between an installed position and a locked position. The strength of the magnet to be used is to be selected so that the magnetic strengths is sufficiently strong, so that the engagement means can be displaced without effort. The magnetic strength to be selected thereby depends on the size of the engagement means because the size of the engagement means has to be adapted, depending on the size of the user interface device.

Further embodiments as well as some of the advantages, which are connected to these and further embodiments, become clear and will be easier to understand due to the following detailed description with reference to the accompanying figures.

### BRIEF DESCRIPTION OF THE DRAWINGS

The figures are only a schematic illustration of an embodiment of the invention, in which:

FIG. 1 shows a front-side exploded view of the fastening assembly,

FIG. 2 shows a further, rear-side exploded view of the fastening assembly,

FIG. 3 shows a detail view in exploded illustration on the rear side of the user interface device and of the holding frame,

FIG. 4 shows a side view according to FIG. 3,

FIG. 5 shows a detailed view onto the magnetic connector elements in the housing of the user interface device and of the holding frame,

FIG. 6 shows a schematic view of the locking device according to a first embodiment in the housing of the user interface device,

FIG. 7 shows a detailed view onto a locking device according to FIG. 6, and

FIG. 8 shows a schematic view of the locking device according to a further embodiment in the housing of the user interface device.

### DETAILED DESCRIPTION

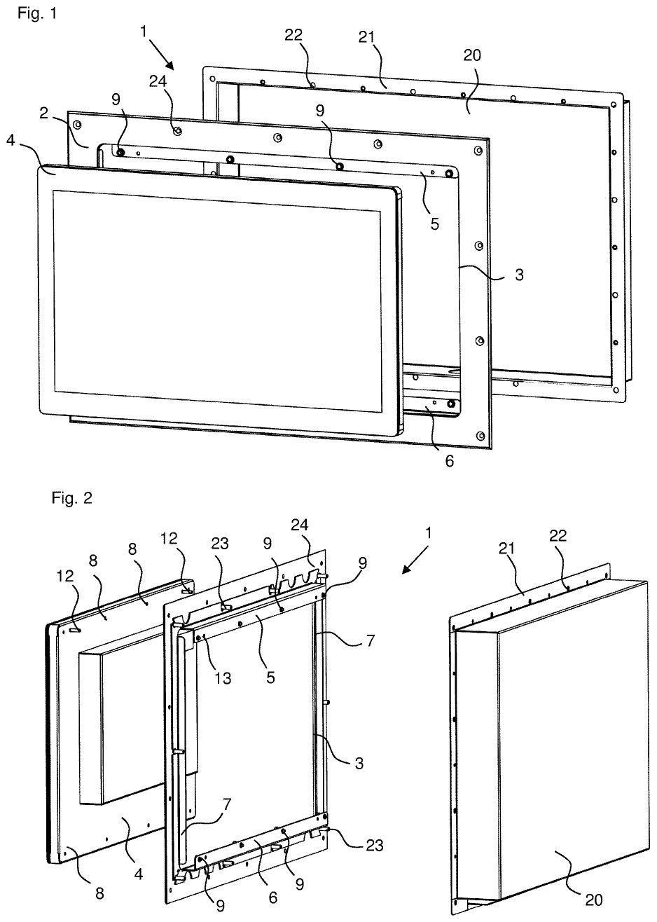

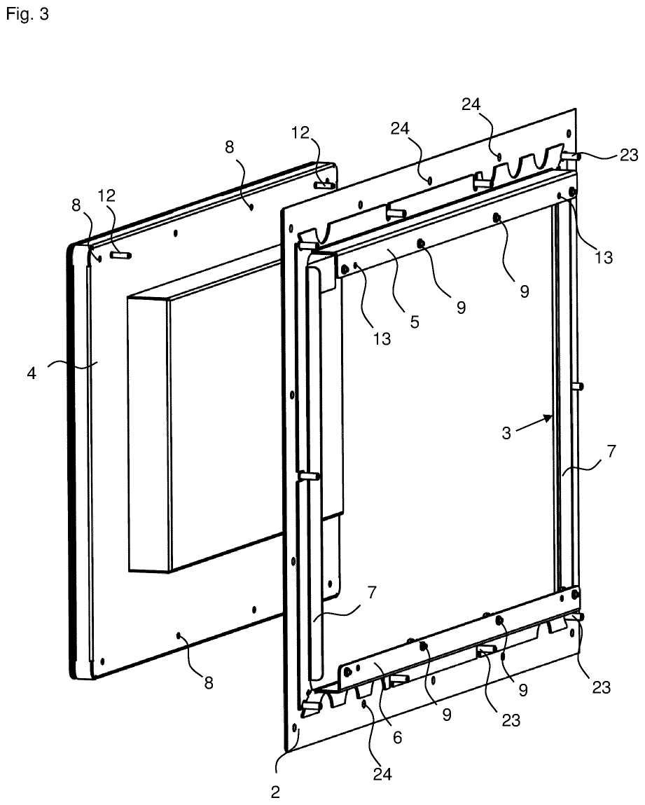

A user interface device 1 with a housing 4 as well as a holding frame 2 for the user interface device 1 is shown in FIG. 1, wherein the housing 4 can be magnetically mounted in the holding frame 2. The holding frame 2 has an opening 3, into which the housing 4 of the user interface device 1 can be inserted in a flush manner, thus be accommodated. As also shown in FIG. 2, the user interface device 1 further has an optional installation enclosure 20, which serves the purpose of storing the housing 4 in a dust-free manner, whereby the entire device, here always referred to as user interface device, becomes permissible for the standard IP65, which is required in clean rooms.

In order to fasten the installation enclosure 20, the latter has a flange 21, which runs so as to protrude around the edge of the installation enclosure 20. Through openings 22 are introduced into this flange 21. The installation enclosure 20 can be connected to the holding frame 2 by means of screw connections or rivetings, for the purpose of which the holding frame 2 likewise has through openings 24 revolving arounds its edge.

The housing 4 is rectangular and has a small thickness.

In order to be able to detachably connect the housing 4 to the holding frame 2, a plurality of magnetic connector elements 8, 9, which correspond to one another, is present in the housing 4 as well as in the holding frame 2. On the one hand, magnetic connector elements 8 are thereby positioned in the housing 4 and, on the other hand, the magnetic connector elements 9 corresponding in pairs are positioned on the holding frame 2.

So that the housing 4 can be inserted into the holding frame 2 so that its front side is flush with a front side of the holding frame 2, thus that the surface of the housing 4 and the front side of the holding frame 2 comes to rest in a same plane, the holding frame 2 has holding rails 5, 6, which extend away from the rear side of the holding frame 2. The holding rails 5, 6 are angular, wherein the holding rails 5, 6 form a right angle, which points to the accommodating opening 3.

A bearing surface for the housing 4 of the user interface device 1 is thus formed, wherein the dimension of the angular holding rails 5, 6 corresponds to a depth of the housing 4 of the user interface device 1. As shown in FIG. 2, an upper holding rail 5 is arranged on an upper longitudinal edge and a lower holding rail 6 on a lower longitudinal edge of the opening 3. A side panel, which is provided for guiding the housing 4 into the holding rails 5, 6, is in each case arranged on the side edges of the opening 3 of the holding frame 2. Fastening pins 23 can further be provided, which provide for a correct connection of the holding frame 2 with the holding rails 5, 6. These fastening pins 23 can be threaded bolts or similar components.

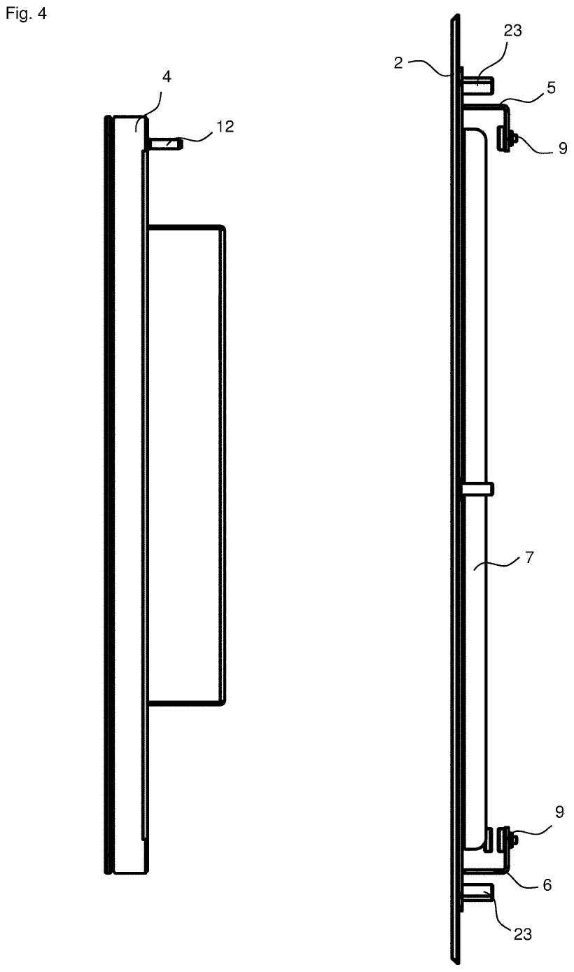

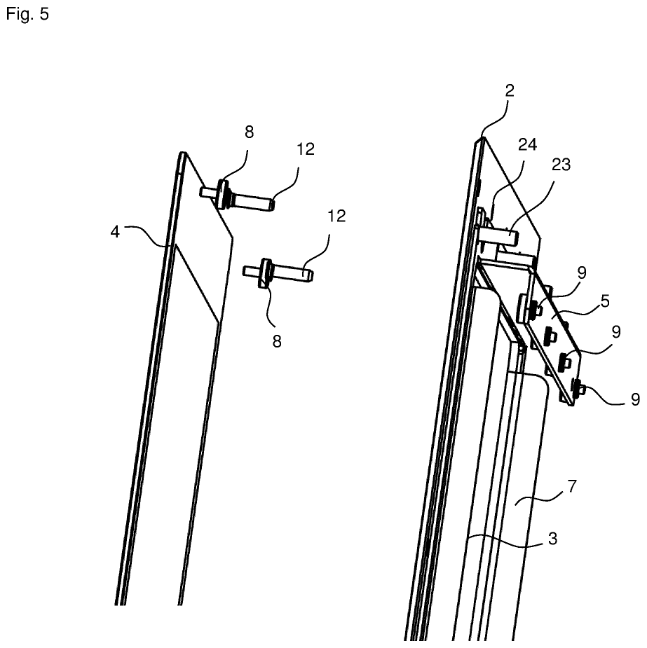

As FIGS. 3, 4 and 5 further show, several first and second magnetic connector elements 8, 9 are arranged in the housing 4 and on the holding frame 2 so as to be distributed equidistantly. The first magnetic connector elements 8 are present on an upper or lower edge, respectively, of the housing 4, preferably on the rear side. Second magnetic connector elements 9 are attached to the upper or lower holding rail 5, 6, respectively. The planes, in which the magnetic connector elements 8, 9 are present, are thereby parallel to one another, so that, when the housing 4 is inserted into the accommodating opening 3, the magnetic connector elements 8, 9 are matched to one another so that the position of the first magnetic connector element corresponds to the position of the second magnetic connector element 9. The magnetic connector elements 8, 9 have magnets or magnetizable materials, so that the housing 4 of the user interface device 1 can be held by means of a predefined attractive force between the first and second magnetic connector element 8, 9. The predefined, magnetic attractive force is provided by magnets with known magnetic field strength.

For the guided installation of the user interface device 1 into the accommodating opening 3, the housing 4 has mechanical guide pins 12 on its rear side facing the holding frame 2. These guide pins 12 correspond to guide openings 13, which are provided in the holding frame 2 or in the holding rails 5, 6, respectively.

The housing 4, which is inserted into the accommodating opening 3, of a monitor or touch-sensitive display, or also of a keyboard, not shown figuratively, can be locked with the holding frame 2, so that the user interface device 1 cannot be removed without authorization.

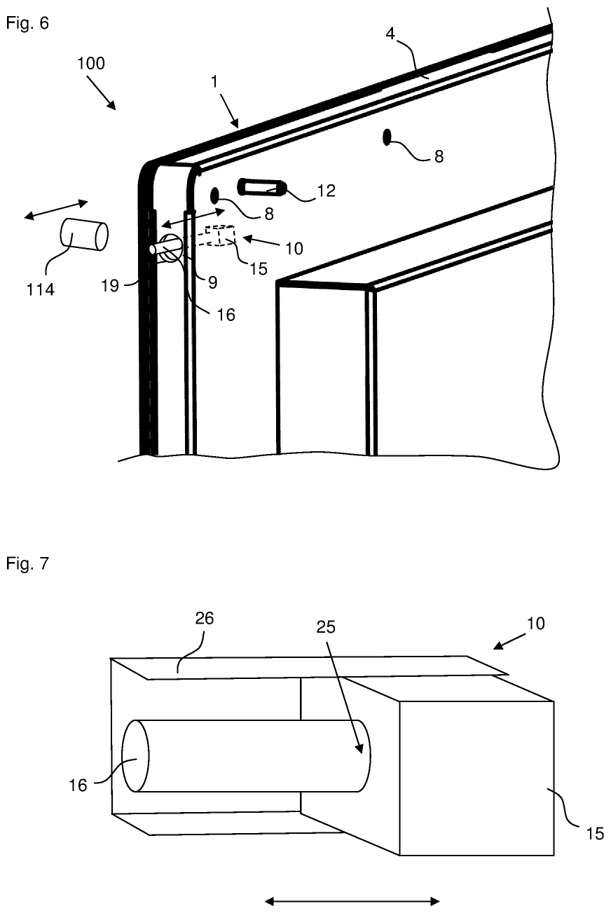

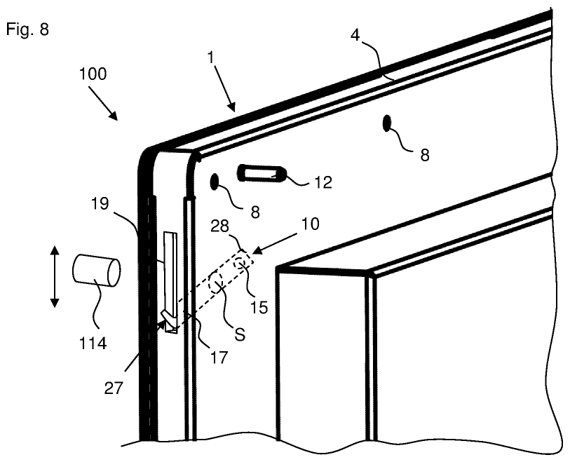

A locking device 10 is illustrated in FIG. 6, which locks the housing 4 with the holding frame 2. The engagement means of the locking device 10 is shown in FIG. 6 as a linearly displaceable pin 16, which is mounted in the housing 4 and can be moved between an installed position and a locked position (direction of the double arrow in FIG. 6). For this purpose, the holding frame 2 has an engagement opening (not illustrated figuratively), such as a slit or a bore, into which the pin 16 can be inserted. In order to be able to be moved from the housing 4 through a through opening 19 provided for this purpose, the pin 16 has a magnetic element 15, which is present on its end 25 remaining in the housing 4. This magnetic element 15, as shown in FIG. 7, can be guidably mounted within a guide rail 26. The pin 16 extends along the longitudinal extension of the guide rail 26 and is likewise moved linearly when the magnetic element 15 is moved linearly within the guide rail 26.

A movement of the locking device 10 is accomplished by means of an actuating tool 114, as shown in FIG. 6. The actuating tool 114 is part of an assembly set 100, which further comprises the locking device 10. Due to the fact that the magnetic element 15 has a magnet or a magnetizable material, respectively, and the actuating tool 114 likewise comprises a magnet, the engagement means, i.e., the linearly displaceable pin 16, can be displaced by means of magnetic force. For this purpose, a user will attach the actuating tool 114 at a position provided for this purpose and will move it linearly, in order to bring precisely the locking device 10 from a first into another position.

A further locking device 10 is illustrated schematically in FIG. 8, wherein the engagement means is a pivotably mounted hook 17 here. The hook 17 is of an elongate shape and is present within the housing 4, wherein it can, in turn, come out of the housing 4 through the through opening 19. The hook 17 is pivotably mounted about a pivot point S in a plane within the housing 4 parallel to the surface of the housing 4. On a front end 27, the hook 17 peeks out of the through opening 19 out of the housing 4. On an end 28 facing away from the front end 27 of the hook 17, a magnetic element 15 is provided, in turn, which can be moved by means of the actuating tool 114, as it has already been described for FIG. 6. Due to the pivotably movable suspension in FIG. 8, a movement of the actuating tool 114 in a direction, which corresponds to the movability of the hook 17, can be performed.

The actuating tool 114 can either be moved parallel to a longitudinal or transverse extension of the housing 4, movements are also possible, which are not linear, thus circular or curve-like movements, depending on how the locking element 10 is designed. The locking device 10 can thereby engage with an engagement opening 19 in the holding frame 2, thus, for example, with a side panel 7.

### LIST OF REFERENCE NUMERALS

1 user interface device
2 holding frame
3 accommodating opening
4 housing
5 upper holding rail
6 lower holding rail
7 side panel
8 first magnetic connector element
9 second magnetic connector element
10 locking device
12 guide pin
13 guide opening
15 magnetic element
16 pin
17 hook
19 engagement opening
20 installation enclosure
21 flange
22 through openings
23 guide pin
24 through openings
25 end of the pin
26 guide rail
27 front end hook
28 free end hook
100 assembly set
114 actuating tool
S pivot point

1.-9. (canceled)

10. A magnetically mounted user interface device (1) designed for use in a clean room, comprising:
a housing (4);
a holding device (2), the holding device (2) having an opening (3), in which the housing (4) of the user interface device (1) is accommodated in a flush and detachable manner;
at least one first magnetic connector element (8) arranged in or on the housing (4) and
at least one second magnetic connector element (9) arranged in or on the holding device (2)
wherein a position of the at least one first magnetic connector element (8) corresponds to a position of the at least one second magnetic connector element (9), so that the housing (4) arranged in the opening is mounted in a flush and detachable manner in the opening (3) by a predefinable attractive force, which the at least one first magnetic connector element (8) exerts on the at least one second magnetic connector element (9); and
a locking device (10) integrated into the housing (4),
wherein the locking device (10) provides a locking of the housing (4) in the holding device (2),
wherein the locking device (10) has at least one engagement means (17, 19), which is movably mounted in the housing (4) between an installed position and a locked position, and
wherein the holding device (2) has at least one engagement opening, which is formed for engagement with the engagement means (17, 19) in the locked position; and
an installation enclosure (20) detachably fastened on a side of the holding device (2) facing away from the housing (4).

11. The user interface device (1) according to claim 10,
wherein the holding device (2) is a holding frame (2) or a recess.

12. The user interface device (1) according to claim 11,
wherein the holding frame (2) has at least one side panel (7) for laterally guiding the housing (4) of the user interface device (1), the at least one side panel (7) being arranged on a side edge of the opening (3); and/or
wherein the holding frame (2) has an upper holding rail (5), which is arranged on an upper longitudinal edge of the opening (3), and a lower holding rail (6), which is arranged on a lower longitudinal edge of the opening (3).

13. The user interface device (1) according to claim 12,
wherein the at least one first magnetic connector element (8) comprises several first magnetic connector elements (8) distributed in or on the housing (4), and
wherein the at least one second magnetic connector element (9) comprises several second magnetic connector elements (9) distributed in or on the holding device (2), and
wherein for each first magnetic connector element (8), a second magnetic connector element (9) is arranged in a corresponding manner and so as to form a pair.

14. The user interface device (1) according to claim 13,
wherein the second magnetic connector elements (9) are present on the upper holding rail (5) and/or the lower holding rail (6).

15. The user interface device (1) according to claim 14,
wherein the first magnetic connector elements (8) and the second magnetic connector elements (9) comprise magnetic and/or magnetizable materials, and
wherein at least one of the magnetic connector elements (8, 9) of each pair comprises a magnetic material or an electromagnet.

16. The user interface device (1) according to claim 10,
wherein the housing (4) has mechanical guide pins (12) arranged on a rear side facing the holding device (2) for guided installation of the user interface device (1), and
wherein the mechanical guide pins (12) can be detachably engaged with corresponding guide openings (13), which are present in the holding device (2).

17. The user interface device (1) according to claim 10,
wherein the engagement means (17,19) is a linearly displaceable pin (16) or a pivotably mounted hook (17) and/or
wherein the engagement means (17,19) has magnetic or magnetizable material.

18. A kit (100), comprising:
the user interface device (1) according to claim 17; and
an actuating tool (114), which has a magnet and which is formed to move the engagement means (17, 19) by magnetic force between the installed position and the locked position.
